(19) United States
(12) Patent Application Publication
(10) Pub. No.: US 2003/0091113 A1
(43) Pub. Date: May 15, 2003

(54) Motion search apparatus for determining motion vector in accordance with motion vector of macro block neighboring object macro block

(75) Inventors: Yoshinori Matsuura, Hyogo (JP); Atsuo Hanami, Hyogo (JP); Satoshi Kumaki, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/176,133

(22) Filed: Jun. 21, 2002

(30) Foreign Application Priority Data
Nov. 15, 2001 (JP) 2001-350373(P)

(51) Int. Cl. H04N 7/12

(52) U.S. Cl. 375/240.16; 348/699; 375/240.24

(57) ABSTRACT

A search MB determination unit determines whether or not an object macro block is a macro block on which a motion search is carried out. A motion vector determination unit selects an optimal vector of a macro block determined not to carry out a motion search by the search MB determination unit from among neighboring macro blocks. Accordingly, it becomes possible, in comparison with a motion search apparatus that carries out a motion search on every macro block, to eliminate the amount of data to be operated required for the motion search while preventing image quality deterioration.

### BACKGROUND OF THE INVENTION

1. Field of the Invention

The present invention relates to a motion search technology in an image data compression and decompression device, in uniticular, to a motion search apparatus that can reduce the amount of data to be operated while limiting image deterioration to the minimum.

2. Description of the Background Art

In recent years, multimedia technology has been vigorously studied in a variety of fields and, above all, the technology of coding dynamic image signals that contain a vast amount of data has become of uniticular importance. A data compression technology that reduces the amount of data becomes indispensable in order to transmit or store the dynamic image data that contains such a vast amount of data.

In general, dynamic image data has a considerable amount of redundancy due to the mutual relationships between neighboring pixels, the sensory characteristics of a human being, and the like. As one of the data compression technologies that reduce the amount of data by suppressing such redundancy of dynamic image data, there is an MPEG (Moving Picture Experts Group) internationally standardized system. This MPEG system is spreading by being used in digital TV (television) broadcasts, in DVDs (digital versatile disc), or the like.

Processing of motion search is carried out in the data compression of the MPEG system so that data compression can be carried out more effectively for an image of which the motion is great. Such a motion search is a process that is indispensable for highly efficient compression, for implementation of higher image quality, and the like, and occupies a major portion of the MPEG processing operation. Here, the procedure of the motion search is briefly described.

In the MPEG system, the screen is divided into blocks of 16 pixels by 16 pixels so that processing is carried out on a block basis. These blocks of 16 pixels by 16 pixels are called MBs (macro blocks). In the case of the NTSC (National Television System Committee) system, the screen size is formed of 720 pixels laterally and 480 pixels longitudinally of which the amount of data becomes of 1350 MBs having 45 MBs laterally and 30 MBs longitudinally.

FIG. 1 is a diagram showing MBs on which a motion search apparatus carries out a search according to a prior art. The conventional motion search apparatus carries out a motion search for the entirety of the MBs shown in FIG. 1.

FIG. 2 is a flow chart for describing the procedure of a motion search in an MPEG system according to a prior art. In this procedure, a pixel position relative to an MB in the upward to downward direction is denoted as M and a pixel position relative to an MB in the left to right direction is denoted as N.

First, −17 is substituted for the variable M (S101) while −17 is substituted for the variable N (S102). Next, M is incremented by 1 (S103) while N is incremented by 1 (S104). Then, frame evaluation value of the vector (M, N) is calculated (S105). This calculation of the frame evaluation value is carried out by finding the total sum of the differences between the respective pixels of a template block (1 MB of 16 pixels by 16 pixels) and the respective pixels in the region wherein evaluation is carried out within a search window. Here, the search window has a region of ±16 pixels in the upward to downward direction and ±16 pixels in the left to right direction relative to the template block.

Next, the field evaluation value of the vector (M, N) is calculated (S106). This calculation of the field evaluation value is carried out by finding the total sum of the differences between the pixels of each field of the template block and the pixels of each field of the region wherein the evaluation is carried out within the search window.

Next, it is determined whether or not the frame evaluation value and the field evaluation value are of the minimum (S107). In the case that the frame evaluation value and the field evaluation value are not of the minimum (S107, No), the processing proceeds to step S109. In addition, in the case that the frame evaluation value or the field evaluation value is of the minimum (S107, Yes), that vector (M, N) is recorded as the optimal vector in a frame prediction mode or in a field prediction mode (S108).

In step S109, in the case that N in not 16 (S109, No), the processing returns to step S104 so as to repeat the processing hereafter. In addition, in the case that N is 16 (S109, Yes), it is determined whether or not M is 16 (S110). In the case that M is not 16 (S110, No), the processing returns to step S103 so as to repeat the processing hereafter. In addition, in the case that M is 16 (S109, Yes), the recorded vector in the frame prediction mode or field prediction mode is decided on as the optimal vector (S111).

In the above described process, search is carried out while shifting the region wherein the evaluation is carried out within the search window (±16 pixels in the upward to downward direction, ±16 pixels in the left to right direction relative to the template block) by a pixel by pixel so that the optimal vectors in the frame prediction mode and in the field prediction mode are respectively decided.

As described above, however, motion search processes must be carried out for the image data of 1350 MB per one frame in order to carry out the motion search process for images of the NTSC system and a great amount of data to be operated become necessary. In addition, digital broadcasts for high definition screen sizes has started and the number of pixels that should be processed has increased to approximately six times as large as in the NTSC system. Together with this enlargement of screen size and requirement for higher image quality, the motion search range must be increased to include approximately ±100 pixels in the upward to downward direction and in the left to right direction so that the number of operations steadily increases.

In order to reduce the cost for the encoder that carries out the data compression while coping with these systems, it is necessary to reduce the amount of data to be operated in the motion search process while maintaining image quality. There is a problem, however, wherein merely reducing the amount of data to be operated by limiting only the MBs on which the motion search processes are carried out leads to image quality deterioration.

### SUMMARY OF THE INVENTION

An object of the present invention is to provide a motion search apparatus that can reduce the amount of data to be operated required for the motion search while preventing the deterioration of the image quality.

According to one aspect of the present invention, a motion search apparatus includes: a search macro block determination unit determining whether or not the object macro block is a macro block on which a motion search is carried out; a motion search unit carrying out a motion search on the macro block that is determined to carry out a motion search by the search macro block determination unit; and a vector determination unit determining a motion vector for a macro block that is determined not to carry out a motion search by the search macro block determination unit in accordance with a motion vector of a neighboring macro block.

Since the motion vector determination unit determines a motion vector for a macro block that is determined to not carry out a motion search by the search macro block determination unit in accordance with the motion vector of a neighboring macro block, it becomes possible to reduce the amount of data to be operated that is required for the motion search while preventing image quality deterioration in comparison with the motion search apparatus that carries out a motion search on every macro block.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing MBs on which a motion search apparatus carries out a search according to a prior art;

FIG. 2 is a flow chart for describing the procedure of a motion search in an MPEG system according to a prior art;

FIG. 3 is a block diagram showing a configuration example of a motion search apparatus according to the first embodiment of the present invention;

FIG. 4 is a diagram showing MBs on which the motion search apparatus carries out a search according to the first embodiment of the present invention;

FIG. 5 is a block diagram showing a functional configuration of the motion search apparatus according to the first embodiment of the present invention;

FIG. 6 is a flow chart for describing the procedure of the motion search apparatus according to the first embodiment of the present invention;

FIG. 7 is a diagram showing four MBs neighboring the object MB;

FIG. 8 is a flow chart for describing the detail of step S12 shown in FIG. 6;

FIG. 9 is a flow chart for describing the details of steps S22, S24 and S26 of FIG. 8;

FIG. 10 is a diagram showing motion vectors of the MBs neighboring the object MB;

FIG. 11 is a flow chart for describing the detail of step S14 shown in FIG. 6;

FIG. 12 is a block diagram showing the functional configuration of a motion search apparatus according to the second embodiment of the present invention;

FIG. 13 is a flow chart for describing the detail of step S12 according to the second embodiment of the present invention;

FIG. 14 is a diagram for describing the operation of complementary vector generation unit 25;

FIG. 15 is a diagram showing motion vectors of 8 MBs neighboring the object MB;

FIG. 16 is a block diagram showing the functional configuration of a motion search apparatus according to the third embodiment of the present invention;

FIG. 17 is a flow chart for describing the detail of step S12 according to the third embodiment of the present invention;

FIG. 18 is a diagram for describing the operation of a search range determination unit 26;

FIG. 19 is a diagram for describing one example of another search range of the motion search apparatus according to the third embodiment of the present invention;

FIG. 20 is a diagram for describing a search range of a motion search apparatus according to the fourth embodiment of the present invention;

FIG. 21 is a diagram for describing a search range of a motion search apparatus according to the fifth embodiment of the present invention;

FIG. 22 is a diagram for describing a search range of a motion search apparatus according to the sixth embodiment of the present invention;

FIG. 23 is a flow chart for describing the procedure of a motion search apparatus according to the seventh embodiment of the present invention;

FIG. 24 is a flow chart for describing the detail of step S64 shown in FIG. 23;

FIG. 25 is a flow chart for describing the details of steps S76, S78 and S80 shown in FIG. 24;

FIG. 26 is a diagram for describing a search MB determination method for a motion search apparatus according to the eighth embodiment of the present invention;

FIG. 27 is a diagram for describing a search MB determination method for a motion search apparatus according to the ninth embodiment of the present invention; and

FIG. 28 is a diagram for describing a motion selection processing method for a motion search apparatus according to the tenth embodiment of the present invention.

### DESCRIPTION OF THE PREFERRED EMBODIMENTS

(First Embodiment)

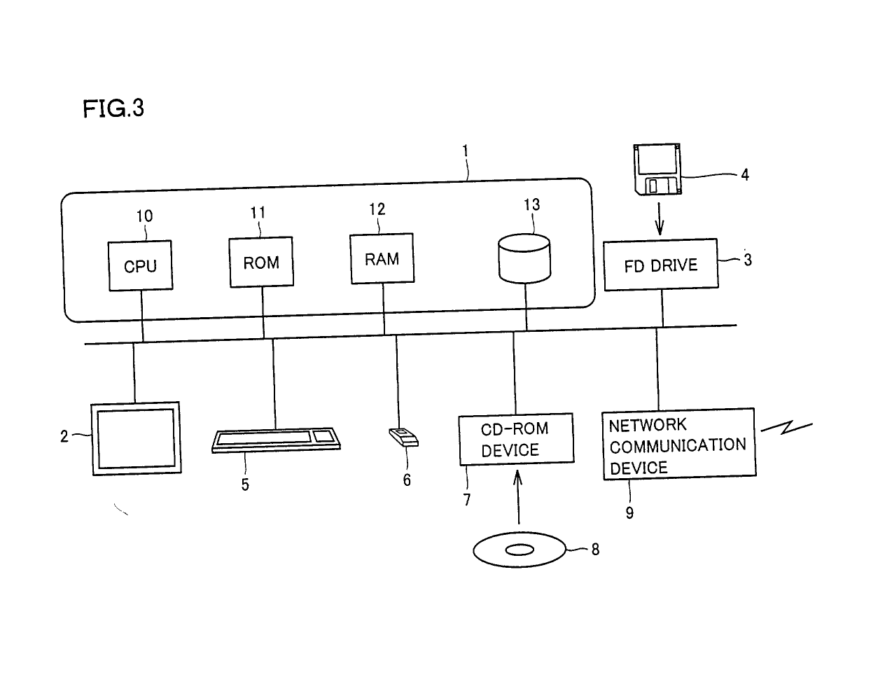

FIG. 3 is a diagram showing a configuration example of a motion search apparatus according to the first embodiment of the present invention. The motion search apparatus includes a computer body 1, a display device 2, an FD drive 3 in which an FD (flexible disk) 4 is mounted, a keyboard 5, a mouse 6, a CD-ROM device 7 in which a CD-ROM (compact disk-read only memory) 8 is mounted and a network communication device 9. A motion search program is supplied by a recording medium such as FD 4 or CD-ROM 8. The motion search program is carried out by computer body 1 and, thereby, a motion search is carried out. In addition, the motion search program may be supplied to computer body 1 from another computer via a communication line. Here, though computer body 1 carries out the motion search program and, thereby, the motion search is implemented, this process may be, of course, implemented by hardware.

Computer body 1 includes a CPU (central processing unit) 10, a ROM (read only memory) 11, a RAM (random access memory) 12 and a hard disk 13. CPU 10 carries out a process while inputting/outputting data to/from display device 2, FD drive 3, keyboard 5, mouse 6, CD-ROM device 7, network communication device 9, ROM 11, RAM 12 or hard disk 13. A motion search program recorded on FD 4 or CD-ROM 8 is stored by means of CPU 10 in hard disk 13 via FD drive 3 or CD-ROM device 7. CPU 10 carries out a motion search program by properly loading it in RAM 12 from hard disk 13 so as to carry out a motion search.

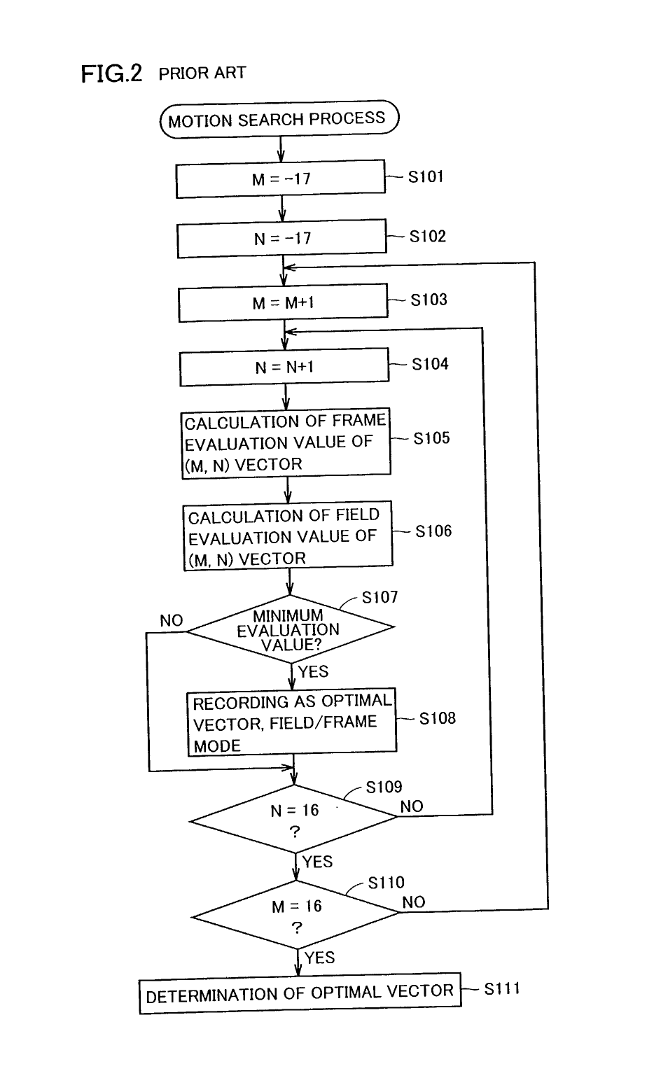

FIG. 4 is a diagram showing MBs on which the motion search apparatus according to the first embodiment of the present invention carries out a search. The motion search apparatus according to the present embodiment carries out a motion search on every other MB shown in a hatched pattern in FIG. 4. Accordingly, the number of MBs on which a motion search is carried out is halved. A motion search process is carried out on these blocks in accordance with the procedure described in reference to FIG. 2.

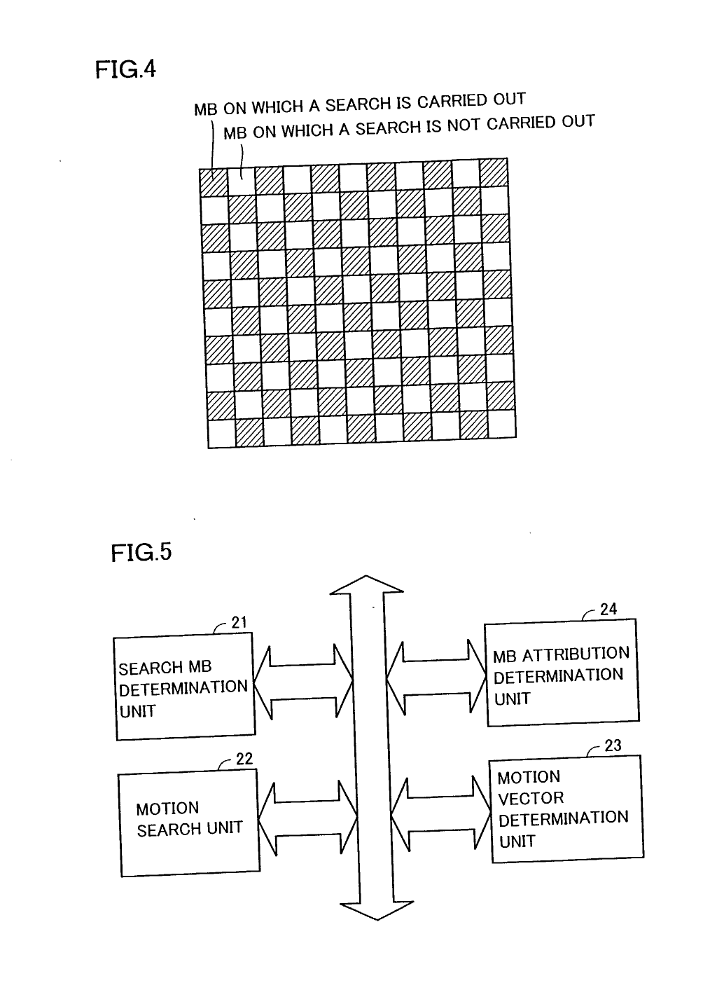

FIG. 5 is a block diagram showing a functional configuration of the motion search apparatus according to the first embodiment of the present invention. The motion search apparatus includes a search MB determination unit 21 for determining whether or not the object MB is an MB on which a motion search is carried out, a motion search unit 22 for carrying out a motion search on an MB that is determined to carry out a motion search by search MB determination unit 21, a motion vector determination unit 23 for determining a motion vector of an MB on which a motion search is not carried out in accordance with the motion vector of an MB neighboring an MB that is determined not to carry out a motion search by search MB determination unit 21 and an MB attribution determination unit 24 for carrying out an Inter/Intra determination (MB attribution determination) of the object MB.

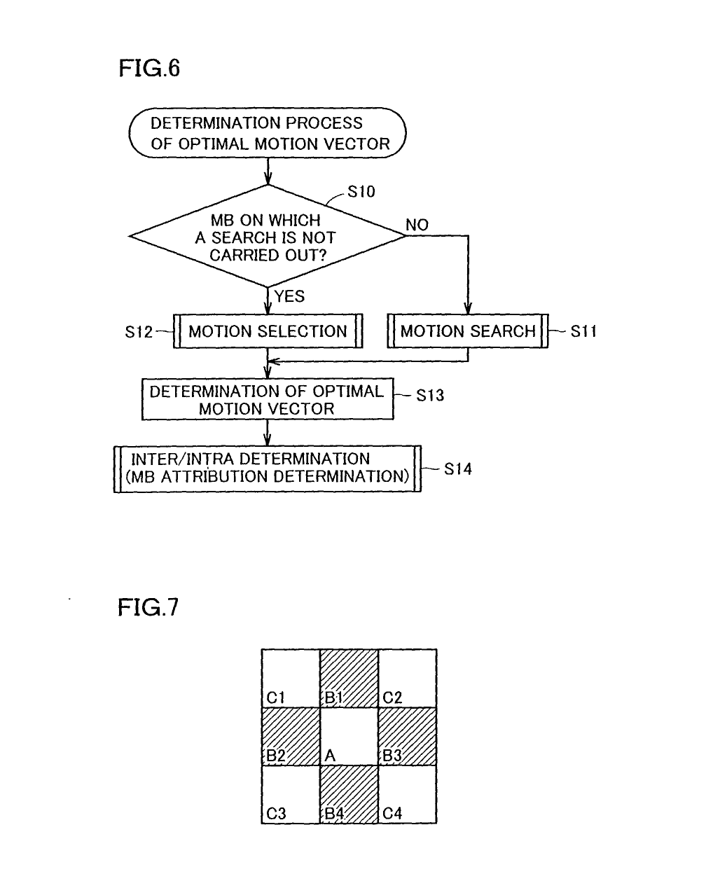

FIG. 6 is a flow chart for describing the procedure of the motion search apparatus according to the first embodiment of the present invention. First, search MB determination unit 21 determines whether or not the object MB is an MB on which a motion search is not carried out (S10). In the present embodiment every other MB, shown by the hatched pattern in FIG. 4, is determined to be MBs on which a search is carried out and the other MBs are determined to be MBs on which a search is not carried out.

In the case that the object MB is determined to be an MB on which a search is carried out (S10, No), motion search unit 22 carries out a motion search on this MB (S11). The procedure of a motion search by motion search unit 22 is the same as that of a conventional motion search described in reference to FIG. 2 and, therefore, the detailed description thereof will not be repeated. In the case that the object MB is determined to be an MB on which a motion search is not carried out (S10, Yes), motion vector determination unit 23 selects the optimal vector from among motion vectors of the four MBs neighboring the object MB (S12).

FIG. 7 is a diagram showing the four MBs neighboring the object MB. When the object macro block is denoted as A, four macro blocks B1 to B4 neighboring macro block A on its top, bottom, left and right are selected. Macro blocks B1 to B4 are respectively MBs on which a motion search is carried out and the optimal vectors are already determined.

Next, motion vector determination unit 23 determines the optimal motion vector from among the optimal vectors determined in step S11 or S12 (S13). Then, an Inter/Intra determination (MB attribution determination) of the object MB is carried out (S 14) and the processing is completed.

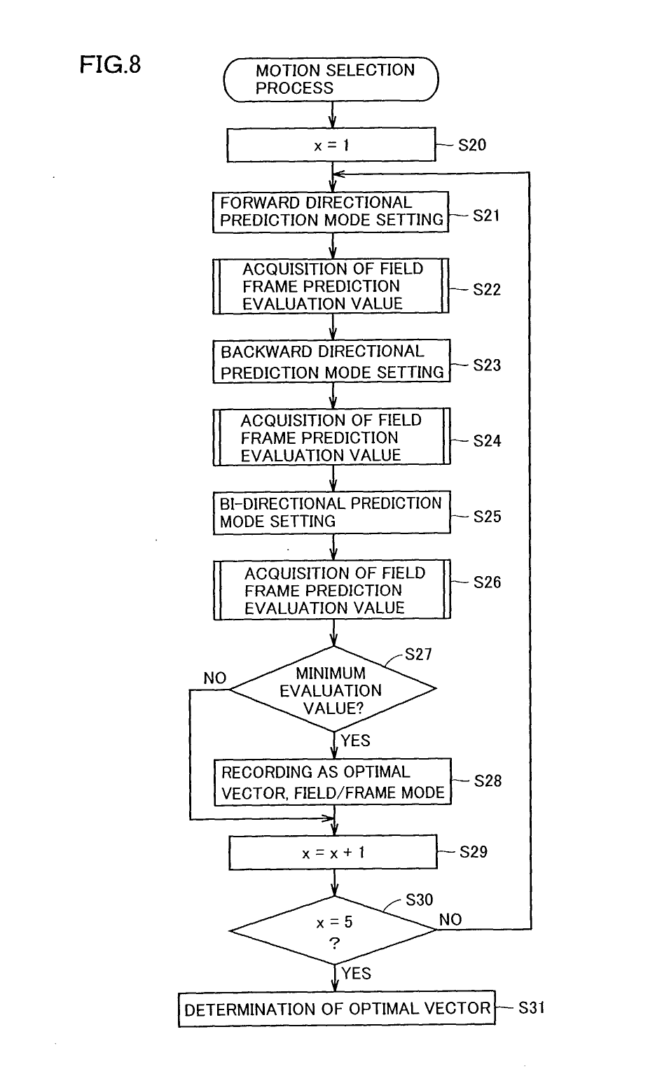

FIG. 8 is a flow chart for describing the detail of step S12 shown in FIG. 6. First, motion vector determination unit 23 substitutes 1 for the variable x (S20). This variable x corresponds to a macro block Bx (B1 to B4) of FIG. 7. Then, the mode is set to the forward direction prediction mode (S21) and the field prediction evaluation value and the frame prediction evaluation value are acquired based on the field vector and the frame vector of an MB neighboring the object MB (S22).

Next, motion vector determination unit 23 sets the mode to the backward direction prediction mode (S23) and the field prediction evaluation value and the frame prediction evaluation value are acquired based on the field vector and the frame vector of an MB neighboring the object MB (S24). These prediction evaluation values are acquired in the same manner as for the prediction evaluation values at the time of the forward direction prediction mode.

Next, motion vector determination unit 23 sets the mode to the bidirectional prediction mode (S25) and the field prediction evaluation value and the frame prediction evaluation value are acquired based on the field vector and the frame vector of the MB neighboring the object MB (S26). These prediction evaluation values are acquired in the same manner as for the prediction evaluation values at the time of the forward direction prediction mode.

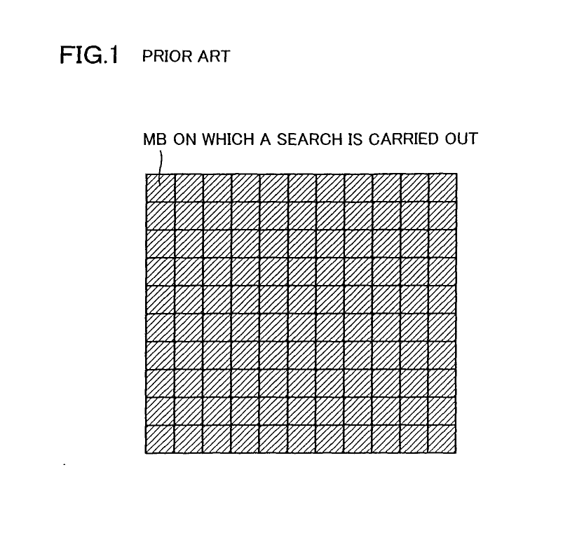

Next, motion vector determination unit 23 compares six prediction evaluation values, in total, of the field prediction evaluation values and the frame prediction evaluation values found in each of steps S22, S24 and S26 so as to determine the minimum evaluation value from among them (S27). Furthermore, motion vector determination unit 23 compares this determined minimum evaluation value with the minimum evaluation value with respect to another neighboring MB that is already stored in a memory device (RAM 12 in FIG. 1) within the computer.

In the case that the minimum evaluation value determined by step S27 is smaller than the evaluation value stored in RAM 12 (S27, Yes), motion vector determination unit 23 updates the minimum evaluation value stored in RAM 12 with the minimum evaluation value determined in step S27 (S28). Furthermore, together with the minimum evaluation value after this update, (1) motion vector, (2) the frame and the type of the field and (3) the type of prediction mode in the forward direction, the backward direction or of bi-direction are stored in RAM 12 (S28). After that, the processing proceeds to step S29.

On the other hand, in the case that the minimum evaluation value determined in step S27 is the evaluation value stored in RAM 12, or greater, (S27, No), motion vector determination unit 23 skips step S28 and the processing proceeds to step S29.

Here, since the prediction evaluation value of the object MB is not stored in RAM 12 in the case of x=1, the minimum evaluation value determined in step S27, the above described optimal vector that corresponds to that, the frame and the type of the field and the type of prediction mode are stored in RAM 12. Afterwards, the processing proceeds to step S29.

In step S29, motion vector determination unit 23 increments the variable x by 1 (S29), and determines whether or not the variable x is 5 (S30). In the case that the variable x is not 5 (S30, No), the processing returns to step S21 so as to repeat the processing hereafter. In this example, the sequential process flow of steps S21 to S30 is repeated four times with respect to the four neighboring MBs.

When the variable x finally coincides with 5 in step S30 (S30, Yes), motion vector determination unit 23 decides the motion vector stored in RAM 12 at this time as the optimal motion vector of the object MB (S31).

The minimum evaluation value is decided for a neighboring MB in each step S27 in the process flow of S21 to S30 of the second to fourth times and, furthermore, the thus decided minimum evaluation value is compared with the minimum evaluation value for another neighboring MB that has been stored in RAM 12 (S27). In the case that the minimum evaluation value that is decided in step S27 is smaller than the evaluation value that is stored in RAM 12 (S27, Yes), the minimum evaluation value decided in step S27, the corresponding optimal vector, the frame and the type of field and the type of prediction mode in the forward direction, the backward direction or of bi-direction with respect to previous contents of RAM 12 are updated. In the case that the minimum evaluation value decided in step S27 is the evaluation value stored in RAM 12, or greater (S27, No), step S28 is skipped so that the processing proceeds to step S29.

When the variable x coincides with 5 in step S30 (S30, Yes), the vector stored in RAM 12 as the optimal motion vector (S31).

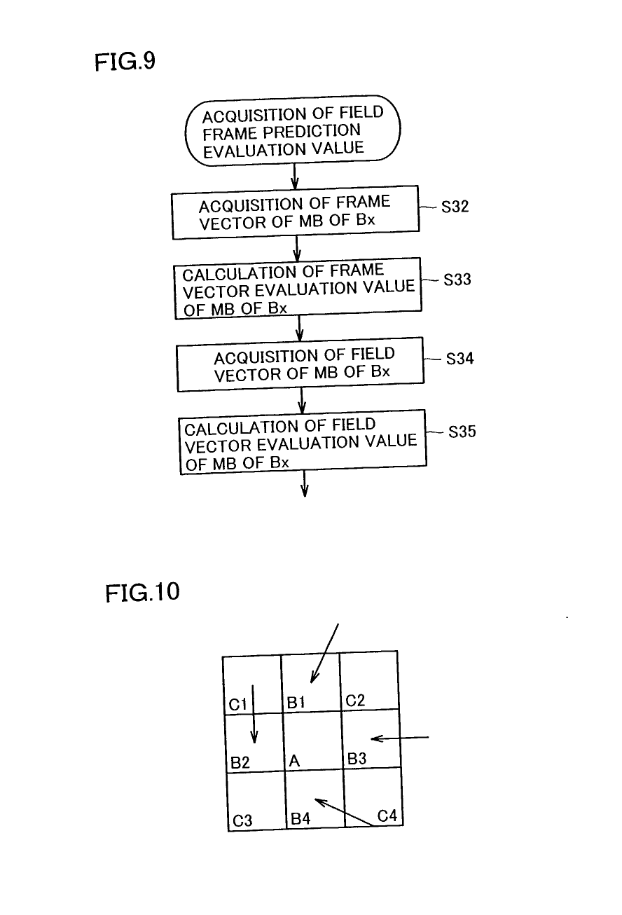

FIG. 9 is a flow chart for describing the detail of steps S22, S24 and S26 of FIG. 8. First, motion vector determination unit 23 acquires a frame vector of a macro block Bx (S32) and the frame vector evaluation value is calculated based on this frame vector (S33).

In the case that the object MB is, for example, macro block A shown in FIG. 7, the frame vector evaluation value is found from the search window for this macro block A and the frame vectors of the MBs (B1 to B4) that neighbor macro block A. That is to say, this is carried out by finding the total sum of the differences between each pixel of the template block (macro block A) and each pixel of the region within the search window in accordance with the frame vector of a neighboring MB.

Next, the motion vector determination unit 23 acquires the field vector of macro block Bx (S34) and calculates the field vector evaluation value based on this field vector (S35). The calculation of this field vector evaluation value is carried out by finding the total sum of the differences between each pixel of the template block (macro block A) and each pixel of the region within the search window in accordance with the field vector of a neighboring MB.

FIG. 10 is a diagram showing the motion vectors of MBs that neighbor the object MB. The evaluation values for the motion vectors of macro blocks B1 to B4 that neighbor macro block A shown in FIG. 10 are found in accordance with the above described process and the motion vector of the minimum evaluation value from among these evaluation values is determined as the optimal vector.

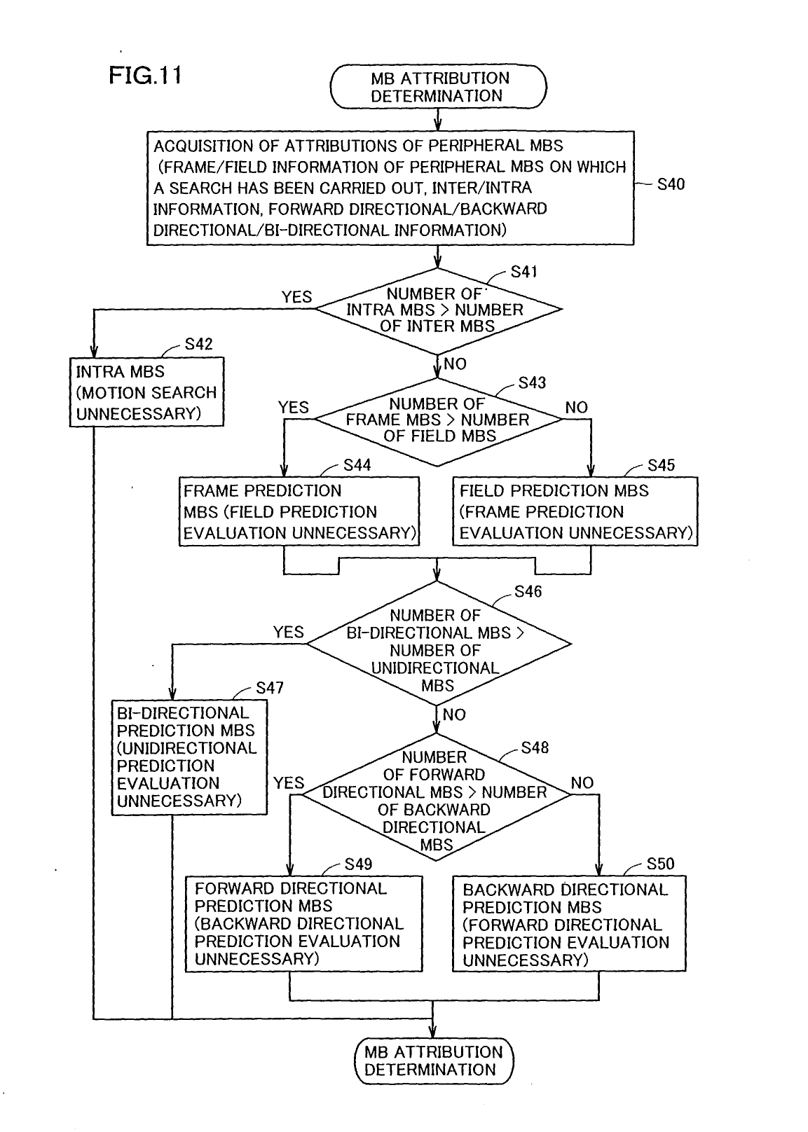

FIG. 11 is a flow chart for describing the detail of step S14 shown in FIG. 6. First, MB attribution determination unit 24 acquires the attributions (frame/field information of peripheral MBs, Inter/Intra information, forward directional/backward directional/bi-directional information) of peripheral MBs that neighbor the object MB (S40). The neighboring peripheral MBs may be four MBs (B1 to B4) that are located so as to neighbor above, below, to the left and to the right, or may be eight MBs that include four MBs (C1 to C4) that are located so as to neighbor diagonally. Then, a comparison of the number of Intra MBs with the number of Inter MBs is carried out (S41). In the case that the number of Intra MBs is greater than that of Inter MBs (S41, Yes), MB attribution determination unit 24 determines the object MB to be an Intra MB (S42) so as to complete the processing. In this case, the motion search becomes unnecessary.

In addition, in the case that the number of Intra MBs is not greater than that of Inter MBs (S41, No), a comparison of the number of frame MBs with the number of field MBs is carried out (S43). In the case that the number of frame MBs is greater than that of field MBs (S43, Yes), MB attribution determination unit 24 determines the object MB to be a frame prediction MB (S44) and the processing proceeds to step S46. In this case, the field prediction evaluation becomes unnecessary. In addition, in the case that the number of frame MBs is not greater than that of field MBs (S43, No), MB attribution determination unit 24 determines the object MB to be a field prediction MB (S45) and the processing proceeds to step S46. In this case, the frame prediction evaluation becomes unnecessary.

In step S46, the number of bi-directional MBs and the number of unidirectional MBs are compared. In the case that the number of bidirectional MBs is greater than that of the unidirectional MBs (S46, Yes), MB attribution determination unit 24 determines the object MB to be a bidirectional prediction MB (S47) and the processing is completed. In this case, unidirectional prediction evaluation becomes unnecessary.

In addition, in the case that the number of bidirectional MBs is not greater than that of the unidirectional MBs (S46, No), the number of forward directional MBs and the number of backward directional MBs are compared (S48). In the case that the number of forward directional MBs is greater than that of backward directional MBs (S48, Yes), MB attribution determination unit 24 determines the object MB to be a forward directional prediction MB (S49) and the processing is completed. In this case, backward directional prediction evaluation becomes unnecessary. In addition, in the case that the number of forward directional MBs is not greater than that of backward directional MBs (S48, No), MB attribution determination unit 24 determines the object MB to be a backward directional prediction MB (S50) and the processing is completed. In this case, forward directional prediction evaluation becomes unnecessary.

As described above, in accordance with the motion search apparatus according to the present embodiment, the optimal motion vector is selected from among the motion vectors of four MBs that neighbor an MB on which a motion search is not carried out and, therefore, it becomes possible, in comparison with conventional motion search apparatus that carries out a motion search for every MB, to greatly reduce the amount of data to be operated that is necessary for the motion search while preventing image quality deterioration.

(Second Embodiment)

A configuration example of a motion search apparatus according to the second embodiment of the present invention is similar to the configuration example of the motion search apparatus according to the first embodiment shown in FIG. 3, of which the detailed descriptions will not be repeated.

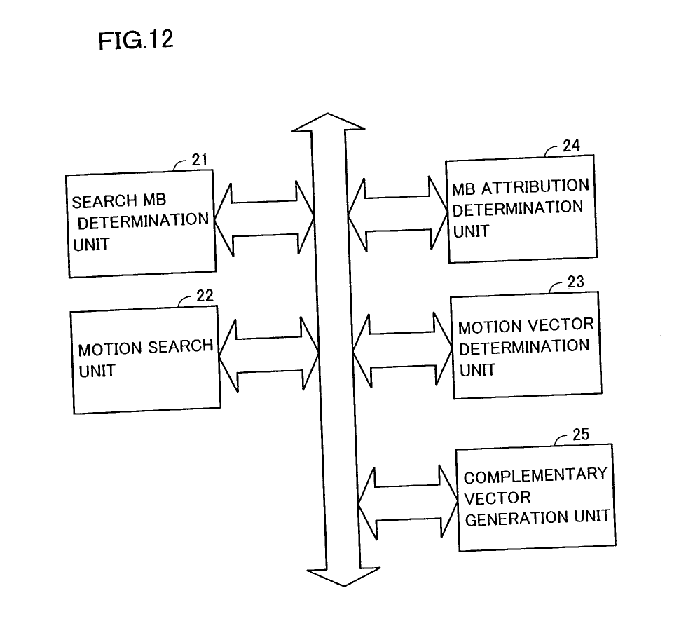

FIG. 12 is a block diagram showing a functional configuration of the motion search apparatus according to the second embodiment of the present invention. The motion search apparatus according to the present embodiment differs from the motion search apparatus according to the first embodiment shown in FIG. 5 only in the point that a complementary vector generation unit 25 for generating a complementary vector based on the motion vectors of the four neighboring MBs is added. Accordingly, detailed descriptions of the configuration and functions will not be repeated.

The procedures for the motion search apparatus according to the second embodiment of the present invention differs from the procedures for the motion search apparatus according to the first embodiment shown in FIG. 6 only in the point that the motion selection process of step S12 differs. Accordingly, the detailed description of the procedures will not be repeated.

FIG. 13 is a flow chart for describing the detail of step S12 according to the second embodiment of the present invention. First, complementary vector generation unit 25 generates complementary vectors for other MBs from the motion vectors of the four MBs neighboring the object MB on its top, bottom, left, and right (S36). Here, variable x corresponds to macro blocks Bx (131 to B4) of FIG. 7.

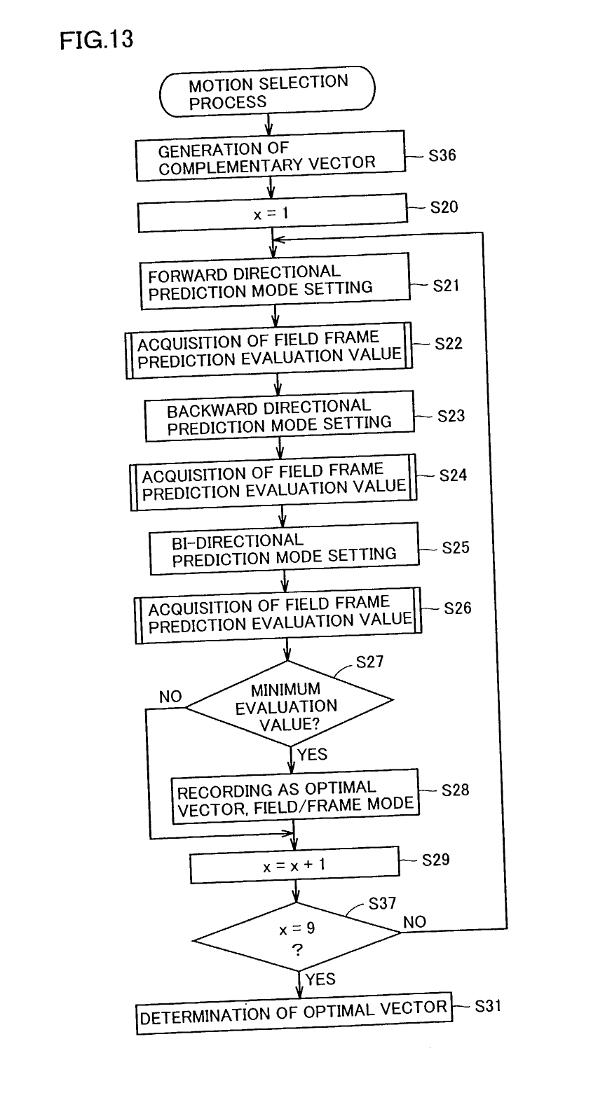

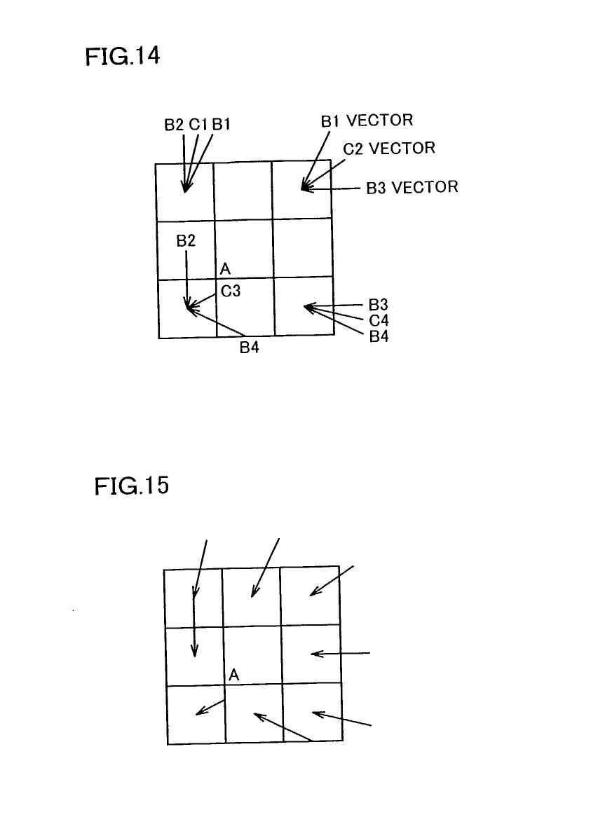

FIG. 14 is a diagram for describing the operation of complementary vector generation unit 25. Complementary vector generation unit 25 generates motion vectors (complementary vectors) of macro blocks C1 to C4 from the motion vectors of four macro blocks B1 to B4 that neighbor the object macro block A. For example, the complementary vector of Cl is generated by averaging the motion vectors of macro blocks B1 and B2 neighboring macro block C1.

The complementary vectors of macro blocks C2 to C4 are respectively generated in the same manner from the motion vectors of macro blocks B1 and B3, from the motion vectors of macro blocks B2 and B4 as well as from the motion vectors of macro blocks B3 and B4. FIG. 15 shows motion vectors of eight MBs that neighbor the object MB.

Next, motion vector determination unit 23 carries out the processes of steps S20 to S29. The processes of steps S20 to S29 are the same as those shown in FIG. 8, of which the detailed descriptions will not be repeated.

Motion vector determination unit 23 determines whether or not variable x is 9 when the processing proceeds to step S37 after step S29. In the case that variable x is not 9 (S37, No), the processing returns to step S21 and the process is hereafter repeated. In addition, in the case that variable x is 9 (S37, Yes), the vector stored in RAM 12 is determined as the optimal motion vector (S31). Accordingly, motion vector determination unit 23 repeats the sequential process flow of steps S21 to S29 eight times in total with respect to eight neighboring MBs.

In accordance with the above described processes, evaluation values for the motion vectors of macro blocks B1 to B4 and for the complementary vectors of macro blocks C1 to C4 that neighbor macro block A shown in FIG. 15 are found and the motion vector or the complementary vector that has become the minimum evaluation value from among these evaluation values is determined as the optimal vector.

As described above, in accordance with the motion search apparatus according to the present embodiment, the optimal motion vector is selected from among the motion vectors of the four MBs that neighbor an MB on which a motion search is not carried out on its top, bottom, left, and right and from among the complementary vectors of the four MBs generated by complementary vector generation unit 25 and, therefore, it becomes possible to further prevent image quality deterioration in comparison with the motion search apparatus according to the first embodiment.

(Third Embodiment)

A configuration example of a motion search apparatus according to the third embodiment of the present invention is similar to the configuration example of motion search apparatus according to the first embodiment shown in FIG. 3, of which the detailed descriptions will not be repeated.

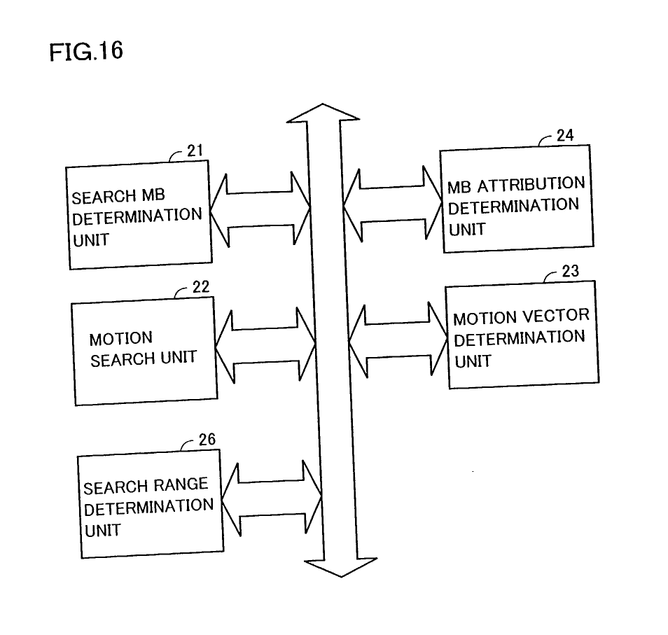

FIG. 16 is a block diagram showing the functional configuration of the motion search apparatus according to the third embodiment of the present invention. The motion search apparatus according to the present embodiment differs from the motion search apparatus according to the first embodiment shown in FIG. 5 in the point that a search range determination unit 26 for determining a search range of the object MB is added. Accordingly, the detailed descriptions of the configuration and the functions will not be repeated.

The procedures of the motion search apparatus according to the third embodiment of the present invention differs from the procedures of the motion search apparatus according to the first embodiment shown in FIG. 6 only in a respect that the motion selection process of step S12 differs. Accordingly, the detailed descriptions of the procedures will not be repeated.

FIG. 17 is a flow chart for describing the detail of step S12 according to the third embodiment of the present invention. First, a search range determination unit 26 determines a region surrounded by the motion vectors of the four MBs that neighbor the object MB on its top, bottom, left, and right as a search range (S51).

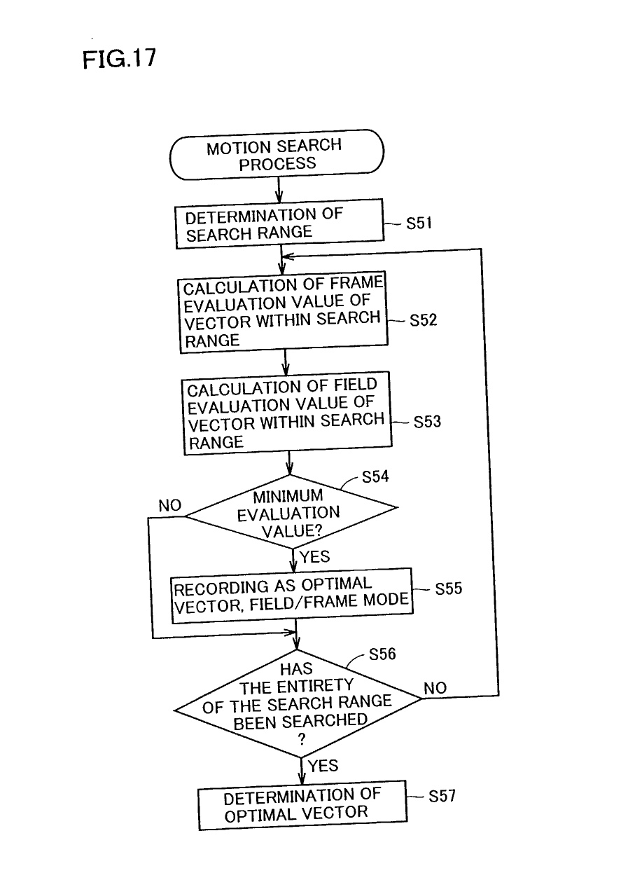

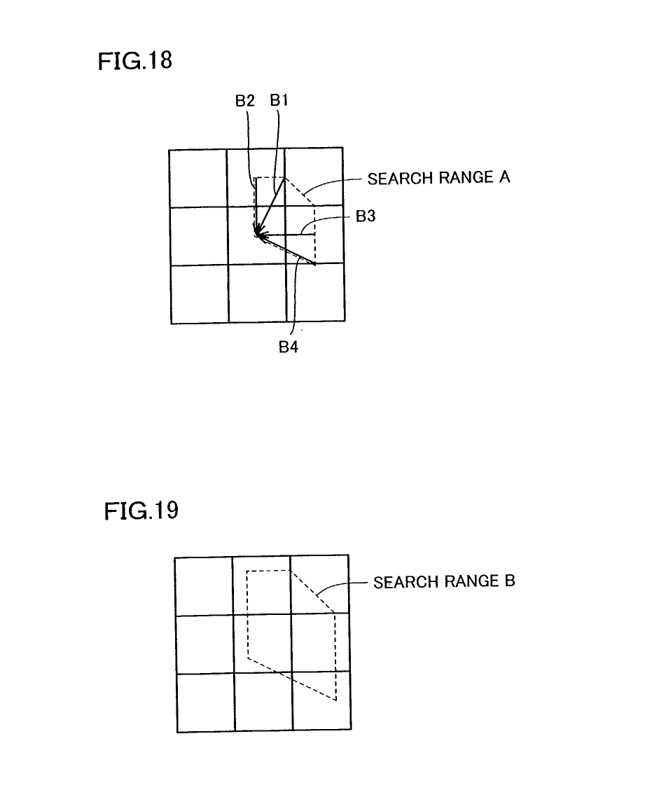

FIG. 18 is a diagram for describing the operation of search range determination unit 26. Search range determination unit 26 determines the region surrounded by the motion vectors of four macro blocks B1 to B4 that neighbor object macro block A as search range A. Here, the vectors shown in FIG. 18 are the motion vectors for four macro blocks B1 to B4 shown in FIG. 7. In addition, as shown in FIG. 19, a search may be carried out by setting a search range B, which is larger than the search range A, that includes search range A.

Next, motion vector determination unit 23 calculates a frame prediction evaluation value based on the frame vectors within the search range determined by search range determination unit 26 (S52). The calculation of this frame prediction evaluation value is carried out with respect to the forward directional prediction mode, the backward directional prediction mode and the bi-directional prediction mode, respectively.

Next, motion vector determination unit 23 calculates the field prediction evaluation value based on field vectors within the search range determined by search range determination unit 26 (S53). The calculation of this field prediction evaluation value is carried out with respect to forward directional prediction mode, the backward directional prediction mode and the bidirectional prediction mode, respectively.

Next, motion vector determination unit 23 compares the two prediction evaluation values found in steps S52 and S53 so as to determine the smaller value as the minimum evaluation value (S54). Furthermore, motion vector determination unit 23 compares the determined minimum evaluation value with the evaluation value that is calculated by using another frame vector or field vector in the search range that is already stored in RAM 12 and updates the evaluation value in RAM 12 to the minimum evaluation value determined in step S54 when the determined minimum evaluation value is smaller than the evaluation value within RAM 12 (S54, Yes).

In addition, together with the evaluation value after the update, the corresponding (1) motion vector, (2) the frame and the type of the field and (3) the type of prediction mode of forward direction, backward direction and bi-direction are stored in RAM 12 (S56) and the processing proceeds to step S56. On the other hand, in the case that the determined minimum evaluation value is no greater than the evaluation value within RAM 12 (S54, Yes), motion vector determination unit 23 skips step S55 so that the processing proceeds to step S56.

Here, at the stage of step S54 that is carried out at the beginning of motion search processing, the evaluation value calculated by using the vectors within the search range is not stored in RAM 12 and, therefore, the minimum evaluation value, the motion vectors, the frame and the type of the field as well as the type of prediction mode determined in step S54 are stored in RAM 12 as they are.

In step S56, motion vector determination unit 23 determines whether or not the entirety within the search range is searched (S56). In the case that there is a vector that is not searched within the search range (S56, No), the processing returns to step S52 and the process hereafter is repeated. In addition, in the case that the entirety within the search range is searched (S56, Yes), the vector stored in RAM 12 is determined as the optimal motion vector (S57).

According to the above described processing, evaluation values for the vectors within search range A shown in FIG. 18 or within search range B shown in FIG. 19 are found and the vector, of which the evaluation value becomes the minimum from among these evaluation values, is determined as the optimal vector.

As described above, in accordance with the motion search apparatus according to the present embodiment, the region surrounded by the motion vectors of the four MBs that neighbor, on its top, bottom, left, and right, an MB that does not carry out a motion search is set as the search range and the motion vectors of the object MB are detected by searching the entire search range and, therefore, it becomes possible, in comparison with the conventional motion search apparatus that carries out a motion search for every MB, to greatly reduce the amount of data to be operated required for the motion search while preventing image quality deterioration.

(Fourth Embodiment)

A motion search apparatus according to the fourth embodiment of the present invention differs from the motion search apparatus according to the third embodiment only in the determination method of a search range. Accordingly, the detailed descriptions of the same configuration and function will not be repeated.

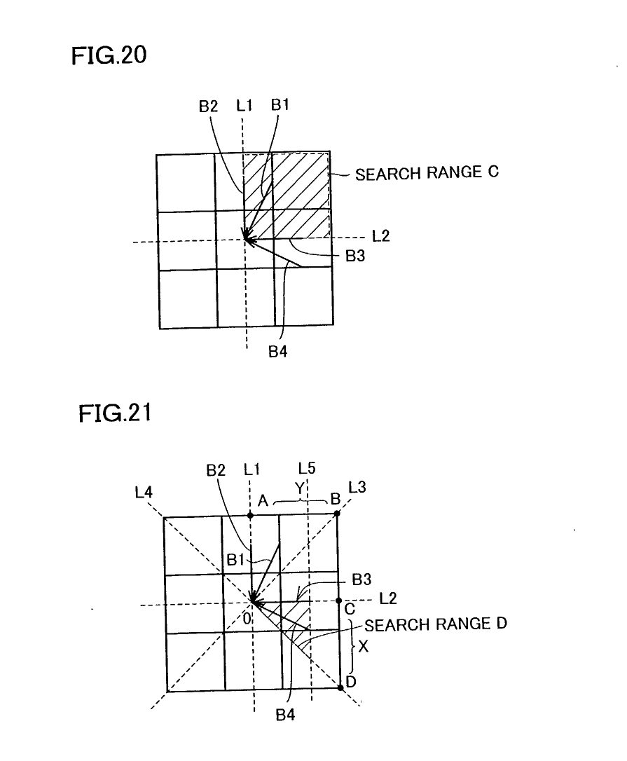

FIG. 20 is a diagram for describing the search range of a motion search apparatus according to the fourth embodiment of the present invention. As shown in FIG. 7, the motion vectors of macro blocks B1 to B4 will be described as an example. A search range determination unit 26 classifies the directions indicated by the motion vectors of the MBs that neighbor the object MB into four directions (for example, four diagonal directions) and the region of the direction in which most motion vectors of the neighboring MBs belong is set as a search range. Concretely, nine MB regions with the object MB at the center are divided into four regions by line L1 in the upward to downward direction and by line L2 in the left to right direction that cross each other at the center of the object MB. These four regions are made to correspond to the four directions into which the motion vectors are classified. In the case that the arrows of the four MB (B1 to B4) vectors that neighbor on its top, bottom, left, and right are shifted to the center of the object MB, the region from among the four regions in which most motion vectors of the four neighboring MBs belong is determined as a search range. In the case of FIG. 18, the region C that includes the motion vectors of three MBs (B1 to B3) is determined as a search range. Here, the classified directions may be classified in further detail such as into eight or sixteen directions.

As described above, in accordance with the motion search apparatus according to the present embodiment, the directions indicated by the motion vectors of the four MBs that neighbor, on its top, bottom, left, and right, an MB that does not carry out a motion search are classified so that the region of the direction in which most motion vectors belong is set as a search range and the motion vector of the object MB is detected by searching the entire search range and, therefore, it becomes possible, in comparison with the conventional motion search apparatus that carries out a motion search on every MB, to greatly reduce the amount of data to be operated required for the motion search while preventing image quality deterioration.

(Fifth Embodiment)

A motion search apparatus according to the fifth embodiment of the present invention differs from the motion search apparatus according to the third embodiment only in the point that the determination method of a search range differs. Accordingly, the detailed descriptions of same configuration and function will not be repeated.

FIG. 21 is a diagram for describing the search range of a motion search apparatus according to the fifth embodiment of the present invention. Here also, as shown in FIG. 7, the motion vectors of macro blocks B1 to B4 will be described as an example. A search range determination unit 26 determines the direction in which most motion vectors of the MBs that neighbor the object MB belong when the directions indicated by the motion vectors of the neighboring MBs are classified into eight directions (for example, eight diagonal directions) and takes the evaluation values that correspond to the vectors of the neighboring MBs into consideration so as to determine the search range.

Concretely, search range determination unit 26 divides the region of nine MBs with the object MB at the center into eight regions by two lines L3 and L4 in the diagonal direction that differ from line L1 in the upward to downward direction and from line L2 in the left to right direction that cross each other at the center of the object MB. These eight regions are made to correspond to the eight directions into which the motion vectors are classified. In the case that the arrows of the vectors of the four MBs (B1 to B4) that neighbor on its top, bottom, left, and right are shifted to the center of the object MB, the region to which most motion vectors of the neighboring eight MBs belong from among the eight regions is determined.

When one region is determined as a result, the region is set as a search range. In this embodiment, however, a region X that is defined by L2 and L4 and that includes the vectors of B3 and B4 (region connecting dots O, C and D in the figure) and a region Y that is defined by lines L1 and L3 and that includes the vectors of B1 and B2 (region connecting dots O, A and B in the figure) are determined to include the same two vectors. In the case that there is a plurality of regions wherein the maximum number of motion vectors that belong to the regions is the same in the above manner, the evaluation values corresponding to the vectors are further referred to so that one of the plurality of regions is set as a search range.

Search range determination unit 26 searches the minimum evaluation value from among the four evaluation values that respectively correspond to the four vectors of B1 to B4 in order to set either region X or Y as a search range so that the region to which the vector of the minimum evaluation value belongs is set as the search range. For example, in the case that the evaluation value that corresponds to the vector of B4 is of the minimum, region X is selected.

As described above, according to the directions and the evaluation values of the motion vectors, one of the eight regions is determined as the search range. However, a portion of the thus determined region is further extracted so that this can be determined as the search range. The size of the motion vector is further taken into consideration in order to determine the search range.

Search range determination unit 26 searches the vector that has the minimum size from among the vectors that belong to region X. In the case that the size of the vector of B3 is of the minimum, line L5 that passes the end of the vector of B3, which is not the head of the arrow, and that extends in the upward to downward direction is assumed and range D surrounded by lines L2, L4 and L5, is determined as the search range.

As described above, in accordance with the motion search apparatus according to the present embodiment, the direction is taken into consideration in which most motion vectors belong when the directions indicated by the motion vectors of the four MBs that neighbor on its top, bottom, left, and right, an MB on which a motion search is not carried out are classified and, at the same time, the sizes of the motion vectors of the neighboring MBs are taken into consideration so as to determine the search range and, therefore, it becomes possible, in comparison with the conventional motion search apparatus that carries out a motion search on every MB, to greatly reduce the amount of data to be operated that are required for the motion search while preventing image quality deterioration.

(Sixth Embodiment)

A motion search apparatus according to the sixth embodiment of the present invention differs from the motion search apparatus according to the third embodiment only in the point that the determination method of a search range differs. Accordingly, the detailed descriptions of same configuration and function will not be repeated.

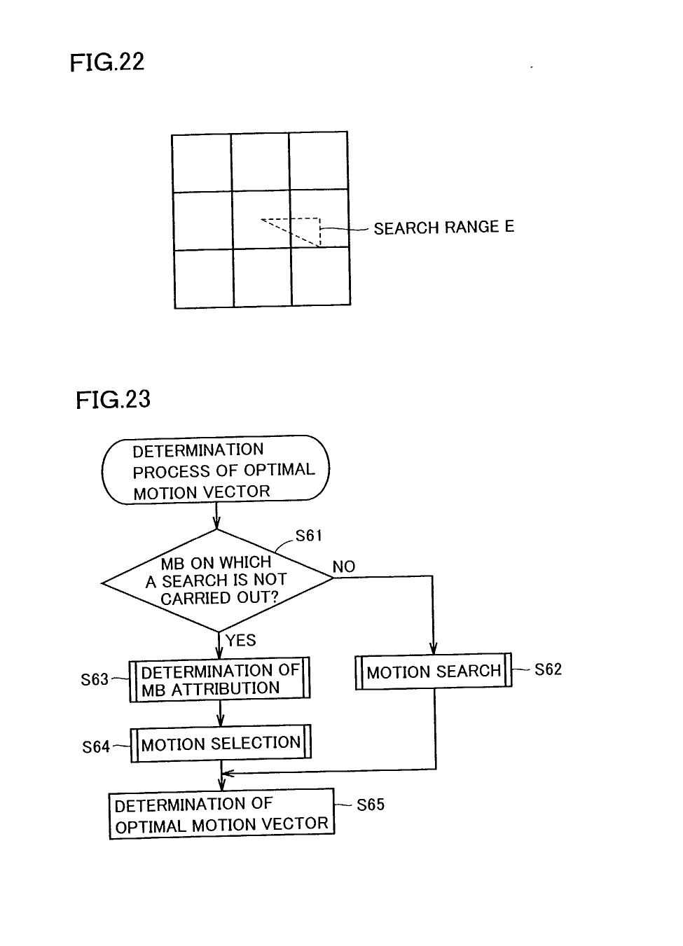

FIG. 22 is a diagram for describing the search range of the motion search apparatus according to the sixth embodiment of the present invention. A search range determination unit 26 sets, as a search range, the overlapping portion of the search range described in the third embodiment and the search range described in the fifth embodiment. That is to say, the overlapping portion of the region surrounded by the motion vectors of the MBs that neighbor the object MB, which is an MB on which a motion search is not carried out, and the region surrounded by the vectors that are included in the direction in which most motion vectors belong when the directions indicated by the motion vectors of the MBs that neighbor the object MB are classified is determined to be a search range. In FIG. 22, the overlapping portion of search range A shown in FIG. 18 and search range D shown in FIG. 21 is determined to be search range E.

As described above, in accordance with the motion search apparatus according to the present embodiment, the overlapping portion of the region surrounded by the motion vectors of the MBs that neighbor the object MB, which is an MB on which a motion search is not carried out, and the region surrounded by the vectors that are included in the direction in which most motion vectors belong when the directions indicated by the motion vectors of the MBs that neighbor the object MB are classified is determined to be a search range and, therefore, it becomes possible, in comparison with the conventional motion search apparatus that carries out a motion search on every MB, to greatly reduce the amount of data to be operated required for the motion search while preventing image quality deterioration.

(Seventh Embodiment)

In the motion search apparatus according to the first embodiment of the present invention, as shown in the flow chart of FIG. 6, the MB attribution determination process (S14) is carried out after the motion selection process (S12) is carried out. Therefore, in the motion selection process (S12) a field prediction and a frame prediction are carried out for the forward directional prediction, for the backward directional prediction and for the bidirectional prediction, respectively, by using the motion vectors of the four MBs that neighbor the object MB and, therefore, it is necessary to calculate the evaluation values of twenty four combinations. The motion search apparatus according to the present embodiment further reduces the amount of data to be operated by reducing the number of calculations of the evaluation values. Here, the functional configuration of the motion search apparatus according to the present embodiment is the same as that of the motion search apparatus according to the first embodiment shown in FIG. 5, of which the detailed descriptions will not be repeated.

FIG. 23 is a flow chart for describing the procedure of the motion search apparatus according to the seventh embodiment of the present invention. First, a search MB determination unit 21 determines whether or not the object MB is an MB on which a motion search is not carried out (S61). In the case that the object MB is determined to be an MB on which a search is carried out (S61, No), a motion search unit 22 carries out a motion search on that MB (S62). Since the procedure of a motion search by the motion search unit 22 is the same as that of the conventional motion search described by using FIG. 2, of which the detailed descriptions will not be repeated.

In addition, in the case that the object MB is determined to be an MB on which a motion search is not carried out (S61, Yes), an MB attribution determination unit 24 determines the attribution of the object MB (S63). The procedure of this MB attribution determination is the same as that described by using FIG. 11, of which the detailed descriptions will not be repeated.

Next, a motion vector determination unit 23 selects the optimal vector from among the motion vectors of the MBs that neighbor the object MB in accordance with the attribution of the object MB (S64). Finally, motion vector determination unit 23 determines the optimal motion vector from among the optimal vectors determined in step S62 or step S64 (S65).

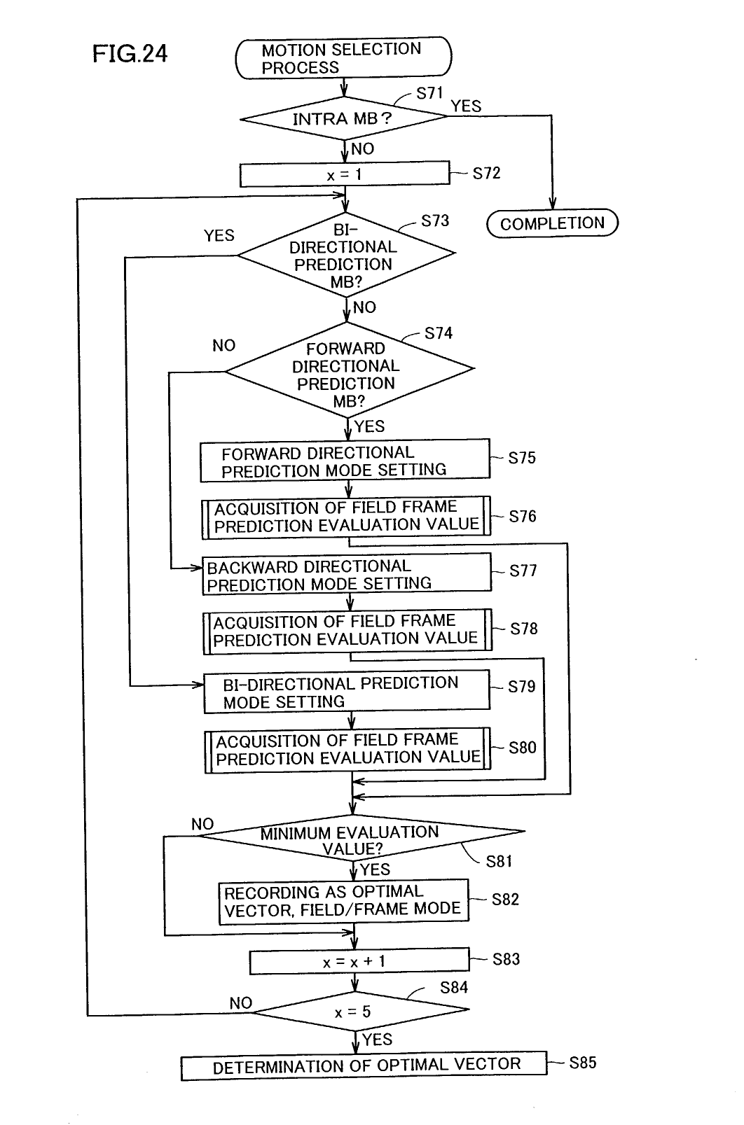

FIG. 24 is a flow chart for describing the detail of step S64, shown in FIG. 23. First, motion vector determination unit 23 determines whether or not the attribution of the object MB is an Intra MB (S71). In the case that the attribution of the object MB is an Intra MB (S71, Yes), the processing is completed without carrying out a motion vector selection process.

Motion vector determination unit 23 substitutes 1 for the variable x (S72) in the case that the attribution of the object MB is an Inter MB (S71, No) based on the attribution determined in step S63 and it is determined whether or not the object MB is a bidirectional prediction MB (S73) based on the attribution determined in step S63. This variable x corresponds to a macro block Bx (B11 to B4) of FIG. 7. In the case that the object MB is a bidirectional prediction MB (S73, Yes), the processing proceeds to step S79. In addition, in the case that the object MB is not a bidirectional prediction MB (S73, No) based on the attribution determined in step S63, the motion vector determination unit 23 determines whether or not the object MB is a forward directional prediction MB (S74). In the case that the object MB is not a forward directional prediction MB (S74, No), the processing proceeds to step S77.

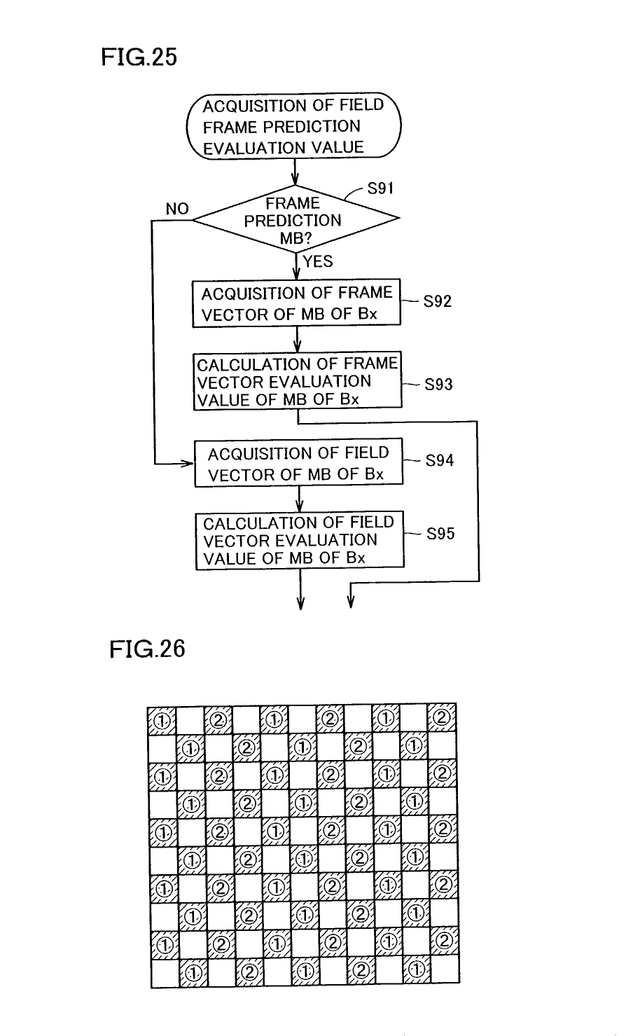

In the case that the object MB is a forward directional prediction MB, motion vector determination unit 23 sets the mode at a forward directional prediction mode (S75) and, as described in FIG. 25, acquires either the field prediction evaluation value or the frame prediction evaluation value in the forward directional prediction mode, which have been selected, based on the motion vectors of the MBs neighboring the object MB (S76).

In step S77, motion vector determination unit 23 sets the mode at a backward directional prediction mode and, as described in FIG. 25, acquires either the field prediction evaluation value or the frame prediction evaluation value in the backward directional prediction mode, which has been selected based on the motion vectors of the MBs that neighbor the object MB (S78).

In step S79, motion vector determination unit 23 sets the mode at the bi-directional prediction mode and, as described in FIG. 25, acquires either the field prediction evaluation value or the frame prediction evaluation value in the bi-directional prediction mode, which has been selected based on the motion vectors of the MBs that neighbor the object MB (S80).

That is to say, motion vector determination unit 23 acquires a prediction evaluation value according to one prediction mode that has been selected based on the attribution (forward directional, backward directional or bidirectional) of the object MB that is determined in step S63.

Next, motion vector determination unit 23 compares the prediction evaluation value that has been acquired in one of steps S74, S78 and S80 with a value stored in RAM 12 within computer 1 (S81) and when the acquired prediction evaluation value is smaller than the value stored in RAM 12 (S81, Yes), the value of RAM 12 is updated to this acquired prediction evaluation value (S82). In addition, motion vector determination unit 23 stores, in RAM 12, the prediction evaluation value as well as the corresponding (1) optimal vector, (2) the frame or the type of the field and (3) the type of prediction mode of forward directional, backward directional or bidirectional (S82). After that, the processing by motion vector determination unit 23 proceeds to step S83. On the other hand, when that acquired prediction evaluation value is determined to be no smaller than the value stored in RAM 12 in step S81, motion vector determination unit 23 skips step S82 so as to proceed to step S83.

In step S83, motion vector determination unit 23 increments the variable x by 1 (S83) and determines whether or not the variable x is 5 (S84). In the case that the variable x is not 5 (S84, No), the processing returns to step S73 and the processing hereafter is carried out again. Accordingly, a sequential process flow of steps S73 to S84 is repeated four times, in total, with respect to the four neighboring MBs.

In the case that the variable x coincides with 5 in step S84 (S84, Yes), motion vector determination unit 23 determines the vector stored in RAM 12 as the optimal motion vector (S85).

FIG. 25 is a flow chart for describing the details of steps S76, S78 and S80 shown in FIG. 24. First, motion vector determination unit 23 determines whether or not the object MB is a frame prediction MB based on the attribution of the object MB that has been determined in step S63 (S91). In the case that the object MB is not a frame prediction MB (S91, No), the processing proceeds to step S94 for processing.

In the case that the object MB is a frame prediction MB (S91, Yes), a frame vector of macro block Bx is acquired (S92) and the frame vector evaluation value is calculated based on this frame vector (S93). Here, the calculation method of this frame vector evaluation value is the same as that described in the first embodiment.

In step S94, a field vector of macro block Bx is acquired and the field vector evaluation value is calculated based on this field vector (S95). Here, the calculation method of this field vector evaluation value is the same as that described in the first embodiment. That is to say, motion vector determination unit 23 makes a selection to carry out steps S92 and S93 or to carry out steps S94 and S95 in accordance with the attribution determined in step S63 so as to calculate either the frame vector evaluation value or the field vector evaluation value. This calculated evaluation value becomes the prediction evaluation value that is acquired in each of steps S76, S78 and S80.

As described above, in accordance with the motion search apparatus according to the present embodiment, it is determined whether or not the calculation of the frame vector evaluation value and the field vector evaluation value is necessary in accordance with the attribution of the object MB and, therefore, it becomes possible, in comparison with the motion search apparatus according to the first embodiment to further reduce the amount of data to be operated required for the motion search.

(Eighth Embodiment)

A motion search apparatus according to the eighth embodiment of the present invention differs from the motion search apparatus according to the first embodiment only in the determination method for the MBs to be searched. Accordingly, detailed descriptions of same configuration and function will not be repeated.

FIG. 26 is a diagram for describing a search MB determination method of the motion search apparatus according to the eighth embodiment of the present invention. First, a search MB determination unit 21 carries out a motion search on only the MBs \mathring{1} from among every other MB shown in FIG. 26. Then, it is determined whether or not the directions and the sizes of the motion vectors of MBs \mathring{1} are similar and, in the case wherein they are similar, only the motion searches of MBs \mathring{1} are carried out. Here, whether or not the directions of the vectors are similar is determined by classifying the directions of the vectors into four directions, eight directions or sixteen directions. In addition, whether or not the sizes of the vectors are similar is determined by classifying the ratios of the sizes of the vectors to the size of the entire region of the search window into about three to eight groups.

In addition, in the case that the motion vectors of MBs \mathring{1} are not similar, a motion search is carried out on MBs \mathring{2} as well. Here, though in the present embodiment, the degree of reduction in the number of MBs in the horizontal direction is varied, the degree of reduction in the number of MBs in the vertical direction may be varied.

As described above, in accordance with the motion search apparatus according to the present embodiment, the degree of reduction in the number of MBs is varied due to whether or not the motion vectors of the MBs are similar and, therefore, it becomes possible, in comparison with the conventional motion search apparatus wherein a motion search is carried out on every MB, to greatly reduce the amount of data to be operated required for the motion search while preventing image quality deterioration.

(Ninth Embodiment)

A motion search apparatus according to the ninth embodiment of the present invention differs from the motion search apparatus according to the first embodiment only in the point that the determination method for the MB to be searched differs. Accordingly, detailed descriptions of same configuration and function will not be repeated.

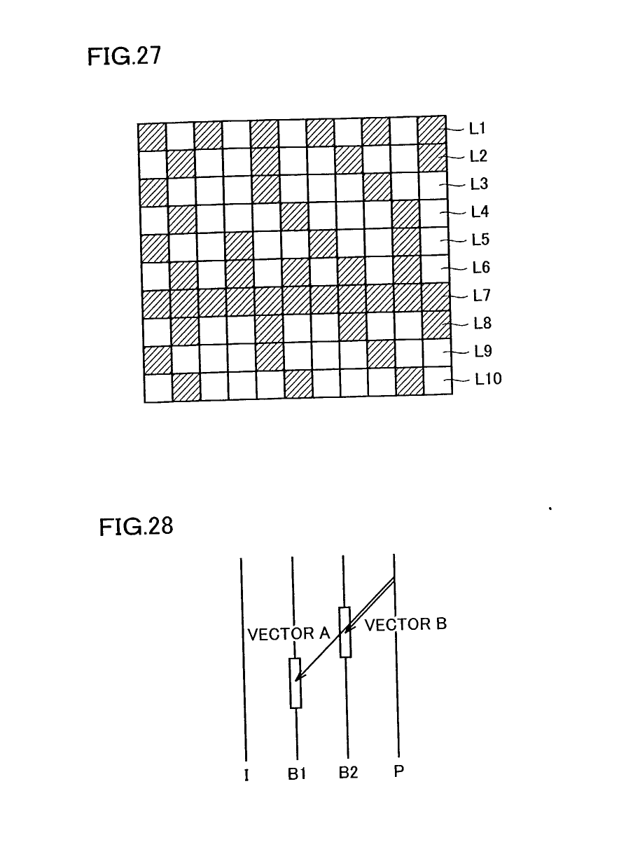

FIG. 27 is a diagram for describing a search MB determination method of a motion search apparatus according to the ninth embodiment of the present invention. First, a search MB determination unit 21 carries out motion searches on the MBs thinned out by selecting every other MB such as MBs on line L1. In the case that the motion vectors of the MBs on line L1 are similar, motion searches of MBs are carried out by increasing the degree of reduction in the number of MBs, such as on line L2. In the same manner, the degree of the reduction in the number of MBs is gradually increased with respect to MBs on line L3 and line L4.

In addition, in the case that the motion vectors of the MBs on line L4 are not similar, a motion searches of MBs are carried out by lowering the degree of reduction in the number of MBs, such as on line L5. In the same manner, the degree of reduction in the number of MBs is gradually lowered with respect to MBs on line L6 and line L7. Here, the degree of reduction may be increased or lowered in a sudden manner in accordance with degree of similarity or degree of dissimilarity of the motion vectors of the MBs.

As described above, in accordance with the motion search apparatus according to the present embodiment, the degree of reduction in the number of MBs on the next line is changed due to whether or not the motion vectors of the MBs on the previous line are similar and, therefore, it becomes possible, in comparison with conventional motion search apparatus that carries out a motion search for every MB, to greatly reduce the amount of data to be operated that is necessary for the motion search while preventing image quality deterioration.

(Tenth Embodiment)

A motion search apparatus according to the tenth embodiment of the present invention differs from the motion search apparatus according to the first embodiment only in the point that the process method of the motion selection differs. Accordingly, detailed descriptions of same configuration and function will not be repeated. In the first embodiment, motion vectors of the neighboring MBs in the same frame are used as vectors that may be selected as the vector of the object MB. In the present embodiment vectors of another frame are allowed to become vectors that may be selected and, thereby, precision of vector prediction is further increased.

FIG. 28 is a diagram for describing a motion selection processing method of a motion search apparatus according to the tenth embodiment of the present invention. As shown in FIG. 28, in the case that there are four frames of I, B1, B2 and P, the order of the coding is the order for I, P, B1 and B2. For example, in the case that vector A that has been searched at the time of the coding of frame B1 crosses the object MB of frame B2 when frame B2 is coded, vector B between frame P and frame B2 is allowed to be a selectable vector and, thereby, increased precision of vector prediction is achieved.

As described above, in accordance with the motion search apparatus according to the present embodiment, in the case that the motion vector is large, vectors of another frame are allowed to be selectable vectors and, therefore, it becomes possible, in comparison with motion search apparatus according to the first embodiment, to increase the precision of the vector prediction and to further prevent image quality deterioration.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A motion search apparatus comprising:
a search macro block determination unit determining whether or not an object macro block is a macro block on which a motion search is carried out;
a motion search unit carrying out a motion search on a macro block determined to carry out a motion search by said search macro block determination unit; and
a motion vector determination unit determining a motion vector of a macro block determined not to carry out a motion search by said search macro block determination unit in accordance with a motion vector of a neighboring macro block.

2. The motion search apparatus according to claim 1, wherein
said search macro block determination unit determines every other macro block on a screen to be a macro block on which a motion search is carried out, and
said motion vector determination unit selects an optimal vector from among motion vectors of the neighboring macro blocks as the motion vector of the macro block determined not to carry out a motion search by said search macro block determination unit.

3. The motion search apparatus according to claim 1, further comprising a complementary vector generation unit complementing a motion vector of a macro block neighboring a macro block determined not to carry out a motion search by said search macro block determination unit based on a motion vector of another neighboring macro block, wherein
said search macro block determination unit determines every other macro block on a screen to be a macro block on which a search is carried out, and
said motion vector determination unit selects an optimal vector from among motion vectors of neighboring macro blocks and a motion vector of another macro block complemented by said complementary vector generation unit.

4. The motion search apparatus according to claim 1, wherein
said search macro block determination unit determines every other macro block on a screen to be a macro block on which a motion search is carried out, and
said motion vector determination unit carries out a motion search of a macro block determined not to carry out a motion search by said search macro block determination unit in a search range surrounded by motion vectors of the neighboring macro blocks.

5. The motion search apparatus according to claim 1, wherein
said search macro block determination unit determines every other macro block on a screen to be a macro block on which a motion search is carried out, and
said motion vector determination unit carries out a motion search on a macro block determined not to carry out a motion search by said search macro block determination unit in a search range in the direction in which most motion vectors of the neighboring macro blocks belong.

6. The motion search apparatus according to claim 1, wherein
said search macro block determination unit determines every other macro block on a screen to be a macro block on which a motion search is carried out, and
said motion vector determination unit decides a search range of a motion search of a macro block determined not to carry out a motion search by said search macro block determination unit in accordance with a direction in which most motion vectors of the neighboring macro blocks belong and sizes of evaluation values corresponding to the motion vectors of the neighboring macro blocks.

7. The motion search apparatus according to claim 1, wherein
said search macro block determination unit determines every other macro block on a screen to be a macro block on which a motion search is carried out, and
said motion vector determination unit carries out a motion search on a macro block determined not to carry out a motion search by said search macro block determination unit in a search range surrounded by motion vectors of the neighboring macro blocks and surrounded by vectors that are included in the direction in which most motion vectors of the neighboring macro blocks belong.

8. The motion search apparatus according to claim 1, further comprising a macro block attribution determination unit determining an attribution of a macro block determined not to carry out a motion search by said search macro block determination unit, wherein
said motion vector determination unit determines the motion vector of the macro block in accordance with the attribution of the macro block determined by said macro block attribution determination unit.

9. The motion search apparatus according to claim 1, wherein said search macro block determination unit reduces the number of macro blocks on a display screen and changes a degree of reduction in the number of the macro blocks on said display screen in accordance with whether or not motion vectors of macro blocks on which a motion search has been carried out said motion search unit are similar.

10. The motion search apparatus according to claim 1, wherein said search macro block determination unit changes a degree of reduction in the number of macro blocks on the next line according to whether or not motion vectors of macro blocks in the previous line are similar.

11. The motion search apparatus according to claim 1, wherein said motion vector determination unit determines a motion vector of a macro block determined not to carry out a motion search by said motion search unit in accordance with a motion vector of a neighboring macro block and a motion vector of a corresponding macro block in another frame.
